(19) United States
(12) Patent Application Publication
(10) Pub. No.: US 2013/0038935 A1
(43) Pub. Date: Feb. 14, 2013

(54) DIFFRACTIVE COMBINER FOR HEAD-UP COLOR DISPLAY DEVICE

(71) Applicants: Hassan Moussa, Illkirck (FR); Idriss El Hafidi, Strasbourg (FR)

(72) Inventors: Hassan Moussa, Illkirck (FR); Idriss El Hafidi, Strasbourg (FR)

(21) Appl. No.: 13/583,235

(22) PCT Filed: Feb. 18, 2011
(86) PCT No.: PCT/EP2011/052447

§ 371 Date: Sep. 7, 2012

(30) Foreign Application Priority Data
Mar. 17, 2010 (FR) 1001068

(51) Int. Cl. G02B 27/01; G02B 5/18

(52) U.S. Cl. 359/567

(57) ABSTRACT

A diffractive combiner for head-up color display device comprises a first optical diffraction grating configured to diffract, in a direction of diffraction, light of a first incident wavelength on the first grating in a direction of incidence, a second optical diffraction grating configured to diffract, in the same direction of diffraction, light of a second incident wavelength on the second grating in the direction of incidence. The first and second optical diffraction gratings are formed in relief on first and second opposed faces of the combiner. The first and/or the second grating is formed as a wavelength multiplexed optical diffraction grating and configured to diffract, in the direction of diffraction, light of a third incident wavelength on the first and/or second optical diffraction grating in the direction of incidence.

### CROSS-REFERENCE TO RELATED APPLICATION

This application is a national stage application and claims the benefit under 35 U.S.C. §371 of published PCT Patent Application Number PCT/EP 2011/052477, filed Feb. 18, 2011, and was published as WO2011/113662 A1 on Sep. 22, 2011, the entire contents of which is hereby incorporated by reference herein.

### TECHNICAL FIELD OF INVENTION

The present invention relates to a head-up display device particularly for a motor vehicle. In particular, the invention relates to a diffractive combiner for such a device, particularly for the display of information in color.

### BACKGROUND OF INVENTION

A head-up display device typically includes a projection unit which produces a light beam intended to be directed towards a combiner for the projection of images, in particular operating or driving information of the vehicle in the form of a virtual image situated in the field of view of the driver. This type of device was initially made on the basis of technologies derived from aeronautical applications. Their manufacturing costs are consequently often high, such as to prevent their commercial exploitation and their large-scale installation in low or medium range vehicles.

The said costs result in particular from the technologies used, which are complicated to implement and which moreover do not always allow mass replication of the combiners with a sufficient guarantee of stability of the optical characteristics. This is, for example, the case for the device disclosed in document JP 1 004 8562, describing a system falling within the field of an index-modulation hologram, the manufacture of which is based on the use of photosensitive plates made from a photosensitive layer with a gelatin base deposited on a substrate acting as a mechanical support. Such a component can only be manufactured in individual units, as it involves a recording performed on an individual basis and it is not suitable for mass production at a reasonable industrial cost. The holographic component formed on this type of photosensitive plate is in addition sensitive to UV radiation, which can damage it, without the addition of protective coatings. This is also the case for the system disclosed in document EP 0467328, showing a volume optical processing combiner manufactured on the basis of gelatins, and requiring a plurality of holographic layers interacting with a plurality of wavelengths, which makes the reliable reproduction of the optical characteristics of the system even more uncertain. Moreover, this system only works in reflection.

A system operating in reflection with a plurality of wavelengths is also described in document U.S. Pat. No. 4,930,847, with a recording process using each time a different geometry and wavelength, based on photosensitive materials of gelatin type having the limitations described above.

Another structure with at least two layers is described in the patent U.S. Pat. No. 6,005,714, the multiplication of the layers increasing the difficulty of maintaining, during mass production, correct stability of the optical function to be provided. The diffractive structure of document U.S. Pat. No. 6,005,714 comprises a transparent substrate in the opposed faces of which are formed diffractive reliefs. The reliefs are combined the one with the other to obtain a diffractive effect on the reflected light while the net diffractive effect on the light passing through the substrate is essentially nullified.

In view of the large amount of information that can be displayed to the driver of a motor vehicle, today there is a need to project color images. In the context of the present specification, “color” image or “full-color” image mean in particular an image obtained by synthesis of monochromatic images in the primary colors (normally red, green, and blue). The superimposition of the monochromatic images allows the secondary colors (cyan, magenta, yellow) or any other color of the chromatic space (e.g. white) to be displayed. The display of images in color by means of a diffractive combiner is not a trivial problem, given that the angle of deviation of the light transmitted or reflected by an optical diffraction grating depends on the wavelength of the light. As a result it is necessary to make sure that the virtual images of the monochromatic images forming the color image are correctly superimposed in the field of view of the driver, and that the parasitic images are placed outside the field of view of the observer.

The combiner disclosed in document EP 0 467 328 already mentioned above comprises a multiplexed holographic optical diffraction grating to diffract, in the same direction, light of a first incident wavelength and of a second incident wavelength on the optical diffraction grating in a direction of incidence. Alternatively, EP 0 467 328 proposes a “multilayer optical diffraction grating”, i.e. a plurality of holographic optical diffraction gratings stacked and stuck together, each of the layers being associated with a particular wavelength. The two alternatives firstly suffer from the great disadvantage that the optical diffraction gratings are formed on photosensitive plates (sensitive to UV radiation), which, in practice, makes the addition of protective layers necessary. Now the fact of having to use a plurality of layers stuck or laminated together complicates the production of the combiner. It is necessary in particular to adopt measures guaranteeing the proper alignment of the different layers at the moment of assembly. Another very big problem is the homogeneity of the different layers, mainly with regard to their ageing. There is a risk of the layers becoming unstuck or of the optical properties of one or the other layer becoming degraded. It follows that the implementation of a combiner such as described in document EP 0467328 is difficult and the result will always be a more or less successful compromise between several parameters to be optimized. It should in addition be noted, the disclosed combiner has a selectivity for two wavelengths. To be able to function in “full-color” mode, at least three layers of optical diffraction gratings or an at least triplexed grating would be necessary. Such an adaptation would therefore cause still greater complexity. Also, in the documents cited above the control of the diffraction efficiency is empirical and very limited, which implies a problem for the standardization of the luminance level of the virtual image obtained.

### SUMMARY OF THE INVENTION

The present invention remedies these inadequacies and proposes a solution that allows mass production of a diffractive combiner compatible with a “full-color” head-up display device.

A diffractive combiner for a head-up display device is proposed, comprising a first optical diffraction grating configured to diffract, in a direction of diffraction, light of a first incident wavelength on the first optical diffraction grating in a direction of incidence, a second optical diffraction grating configured to diffract, in the same direction of diffraction, light of a second incident wavelength on the second optical diffraction grating in the direction of incidence. The combiner comprises a support made of transparent material having opposed first and second faces on which are formed in relief respectively the first and second optical diffraction gratings. At least one of the first and second optical diffraction gratings is formed as a wavelength multiplexed optical diffraction grating, configured to diffract, in the direction of diffraction, light of a third incident wavelength on at least one of the first and second optical diffraction gratings in the direction of incidence.

In other words, the first and second optical diffraction gratings are configured in such a way that the propagation directions of the light diffracted in the first-order of the first, second and third wavelengths leaving the diffractive combiner are equal for the given direction of incidence. The adaptation of the gratings to the wavelength or wavelengths associated with them is performed firstly by adaptation or indeed modulation of the pitch of the grating. Within the meaning of the present specification, a multiplexed grating can be understood as two gratings, each adapted to the diffraction of a wavelength in the required direction (for a given angle of incidence), performed using a single grating with a modulated pitch. In the context of the present specification, it could therefore alternatively be designated as a duplexed grating.

The combiner in accordance with the invention therefore allows the effect of three single (non-multiplexed) optical diffraction gratings to be obtained on a single support formed in one piece. The complexity of the combiner is thus substantially reduced in particular relative to the one described in the application EP 0467328. The fact that the gratings are formed in relief on the opposite faces allows photosensitive materials having to be effectively protected to be dispensed within the combiner. It is therefore possible to produce a single layer combiner (i.e. on a single support), thus overcoming the problems of compatibility of materials and of differential ageing of the state of the art. On the other hand, the relief allows the diffraction efficiency to be controlled very precisely.

Preferably, the light of the first wavelength is green light (wavelength within the range from 506 to 570 nm), the light of the second wavelength is red light (wavelength within the range from 630 to 700 nm) and the light of the third wavelength is blue light (wavelength within the range from 430 to 490 nm). Particularly advantageous wavelength selections would be 532 nm, 633 nm and 445 nm respectively 532 nm, 633 nm and 432 nm.

The support of the diffractive combiner in accordance with the invention is preferably made of glass or of transparent plastics material, for example of PET (polyethylene terephthalate), of PMMA (methyl poly-methacrylate), of PC (polycarbonate), of PVB (polyvinyl butyral) or others. The first and second optical diffraction gratings are preferably so configured that the said direction of diffraction corresponds to the first order of diffraction for the first, second and third wavelengths.

In accordance with an advantageous embodiment of the combiner, the first and second optical diffraction gratings are configured to perform a lens function of same focal length for the first, second and third wavelengths.

The process for manufacture of the gratings of the combiner preferably comprises that of laser interference nanolithography. By this technique, by means of a laser source, interference fringes are produced in a photosensitive layer corresponding to the grating which it is wished to obtain. Then a chemical engraving step is performed so as to obtain relief variations in the photosensitive layer. These relief variations are then transferred to a mold. For the combiner in accordance with the invention this process is performed for both faces. The combiners can then be mass-produced using the two molds, each corresponding to one face, e.g. by injection or embossing.

In an alternative process, the reliefs of the gratings to be produced, could be generated and saved digitally and transposed to the respective molds by digitally controlled engraving or machining. Below we shall describe in more detail the process for manufacture of a single or multiplexed optical diffraction grating by laser interference nanolithography. A light beam is supposed with n, n≧1, wavelengths λi, i=1 to n, which is sent towards the combiner at an angle of incidence θp. The case n=1 corresponds to a single grating, i.e. not multiplexed. The process comprises the following steps:

deposition of a photosensitive layer of uniform thickness on a flat surface of a solid substrate (e.g. glass or quartz);

exposure to light on the photosensitive layer of the interference fringes due to the interference of the two light beams R1 and R2 from a laser source;

transformation of the zones exposed to light corresponding to the interference fringes into relief variations in the photosensitive layer and manufacture of a mold reproducing these variations; and

use of the said mold to transfer the diffractive relief structure from the substrate onto an homogenous transparent plastics element forming the diffractive combiner.

Step b) is performed n times before step c), each time from two tight beams R1 and R2 from a same laser source of wavelength λe, with an angle θi, i=1 to n, between the beam R1 and the beam R2 equal to

θi=arcsin((λe/λi)*sin(θp)) Eq. 1

At the end of n>1 steps of exposure to light the interference of the beams will have generated a grating with variable pitch, corresponding to the superimposition of different single gratings.

The equation 1 above ensures that the diffraction of the light of wavelengths λi takes place in the same direction, for a common angle of incidence. In other words, the pitches are so selected as to superimpose the images associated with the first orders of the three wavelengths. A judicious choice of the angles of incidence θp and diffraction allows an angular difference to be created between the first order of diffraction and the orders of diffraction other than the first as well as the transmitted or reflected light (order 0). It should be noted that on the use of the diffractive combiner, each of the three single gratings (at least two of which are combined in the multiplexed grating) interacts with all the wavelengths present in the light beam emitted by the projection unit. Parasitic virtual images are therefore observed due either to orders of diffraction other than the first, or to the interaction of a grating with a wavelength for which it is not optimized. However, the fact of providing an angular difference between the first order of diffraction and the orders of diffraction other than the first allows the parasitic virtual images to be moved out of the field of view of the user.

To obtain a lens effect (allowing the virtual image to be placed at a predetermined distance from the diffractive combiner), in each of the steps b) one of the interfering beams is selected divergent and having a spherical wavefront and the other is selected as a wave with a plane front. The interference fringes thus obtained form curves.

Steps a)-c) of the process permit the formation of matrices for the manufacture of molds permitting the mass production of combiners. These matrices are formed of a substrate, made of a rigid material, on which is deposited a photosensitive layer sensitive to the wavelength of the laser source employed, which is always the same, only the angle between the two beams being modified from one step b) to the other.

The two light beams from the same source are sent onto the flat surface of the photosensitive layer, causing interference fringes over the whole of the surface to be exposed. The existence of these interferences leads to a variable exposure to light of the surface of the photosensitive layer, which is then exposed to a chemical substance having the property of dissolving the photosensitive material according to its degree of exposure to light. Chemical engraving consequently occurs, insofar as the interference fringes are transformed into variations of relief after dissolution of certain parts of the layer of exposed photosensitive material. It is to be noted that the control of the depth of relief on the surface of the matrix depends on the recording exposure time as well as the duration of the chemical engraving. It is noted that for a long duration of engraving, the reliefs of the fringes are of practically sinusoidal shape, while in the case of briefer application, the outer crests rather have an eroded shape.

The exposure at a plurality of angles (for one of the two beams) leads in this case to the possibility of manufacturing a combiner with a multiplexed surface grating.

After the chemical engraving, the relief surface is subjected to a deposition of a thin conductive layer, permitting the subsequent application of the electro-forming processes to obtain a mold (e.g. made of nickel). Two mold parts are required for the production of a combiner in accordance with the invention: a first to reproduce the diffraction grating on the first face of the combiner, a second for the diffraction grating on the second face, at least one of the two gratings being a multiplexed grating. The mold obtained is then used to transfer the diffractive structures in relief onto an element made of transparent plastics material by mass production means such as embossing or injection.

It is thus possible to obtain a combiner with a single support made of transparent plastics material, the diffractive structures of which are engraved in both faces.

The use of a wave with a spherical front like one of the two writing beams in the different steps b), permits the performance of a lens function. The distance between the center of the wavebands and the photosensitive layer is selected, in each step b) so that an equal focal length is obtained for all the different wavelengths in question.

One aspect of the invention relates to a “full-color” head-up display device. Such a device comprises a projection unit able to project a light beam containing the light of a first wavelength, the light of a second wavelength and of a third wavelength from a color image produced by additive synthesis of monochromatic images of different colors, each of which corresponds respectively to one of the said wavelengths. The head-up display device also comprises a diffractive combiner such as described above, so positioned relative to the projection unit as to receive the light beam projected by the projection unit in the direction of incidence and to diffract at least a part of the light of the first, second and third wavelengths of the light beam in the direction of diffraction, to thus create in the field of view of a user a virtual image in color of the image produced by the projection unit by means of the superimposition of the monochromatic images corresponding to the three wavelengths.

It will be noted that the luminance of the projection unit and the diffraction efficiency of the combiner for each of the different colors can be matched to each other so as to guarantee a well-balanced mixture of colors in the virtual image as well as a luminance of the latter which is suited to the needs of the application.

Advantageously, the multiplexed optical diffraction grating is configured to bend the green and blue light in the direction of the user. The other optical diffraction grating is preferably a single (non-multiplexed) grating configured to bend the red light in the said direction. It will be noted that the multiplexing affects the diffraction efficiency for the wavelengths in question. The diffraction efficiency at the wavelength λ1 of a grating multiplexed for two wavelengths λ1 and λ2 will normally be less than that of a grating optimized for λ1 alone. The choice of blue and green for the multiplexed grating is considered advantageous for the following reasons:

The sensitivity of the human eye to green is higher than its sensitivity to red and to blue both in conditions of low light (scotopic vision) and in daylight conditions (photopic vision).

Blue is the color least present in nature. Consequently, even a weak luminance in blue normally allows there to be a good contrast between the virtual image and its background.

It follows that a higher luminance in red is considered as advantageous. The non-multiplexed grating is therefore selected for red, while the multiplexed grating is adapted for the diffraction of green and blue light. This configuration will also permit the use of red, blue and green light sources of same intensity. It should however be noted that this choice of distribution of the gratings is not unique: it can vary depending on the requirements relative to the external environment and the luminance level required for each color. It can therefore be envisaged to produce a multiplexed grating for blue and red on the first face and a single grating for green on the second face of the combiner. Depending on needs, it is also possible to select the multiplexed grating for green and red the single grating for blue.

Preferably, the first and second optical diffraction gratings of the diffractive combiner are configured to position the virtual image at a distance within the range of 1 to 5 m from the diffractive combiner. For a given distance between the combiner and the projection unit, this characteristic is obtained by an appropriate selection of the focal length created by the lens function of the diffractive combiner.

The first and second optical diffraction gratings of the diffractive combiner are advantageously matched to the positioning of the diffractive combiner so as to remove parasitic virtual images from the field of view of the user. Preferably, the direction of incidence and the direction of diffraction form an angle greater than 30° between them, e.g. greater than 40° to thus place the parasitic virtual images outside the field of view of the user.

In accordance with a preferred embodiment of the head-up display device, the diffractive combiner is constructed to operate in transmission. Alternatively, the diffractive combiner can also be constructed to operate in reflection. The diffractive combiner can then include one or more optical reflection layers, for example partially reflective or dichroic layers, suitable for the wavelengths used in the projection unit. In a reflection configuration, the combiner can be integrated in a plastics layer of the windscreen. In this case, the reflection characteristics are supported by the windscreen and not by the combiner.

If the reflective characteristics are not supported by the windscreen, it is possible to provide the combiner with a reflective layer deposited on the face of the combiner that is most distant from the user.

The diffraction efficiencies of the diffractive combiner for the first, second and third wavelengths are preferably selected as a function of the luminance level of the color virtual image and/or as a function of the color balance corresponding to the first, second and third wavelengths in the virtual image. The diffraction efficiencies of the diffractive combiner can in particular be adjusted by controlling the depth of the reliefs of the first and second optical diffraction gratings.

### BRIEF DESCRIPTION OF DRAWINGS

Other features and characteristics of the invention will become apparent from the detailed description of some advantageous embodiments presented below, by way of illustration, with reference to the attached drawings. These show:

FIG. 1 is a sectional diagram of a diffractive combiner in accordance with the invention;

FIG. 2 is a basic diagram of a head-up display device using the combiner of FIG. 1;

FIG. 3 is a diagram showing the principle of production of a diffractive combiner by laser interference photolithography;

FIG. 4 is an illustration of a head-up display device with a diffractive combiner constructed in transmission;

FIG. 5 is an illustration of a head-up display device with a diffractive combiner constructed in reflection;

FIG. 6 is an illustration of a head-up display device with a diffractive combiner integrated in the windscreen; and

FIG. 7 is a diagram of the geometry of recording by laser interference photolithography.

### DETAILED DESCRIPTION

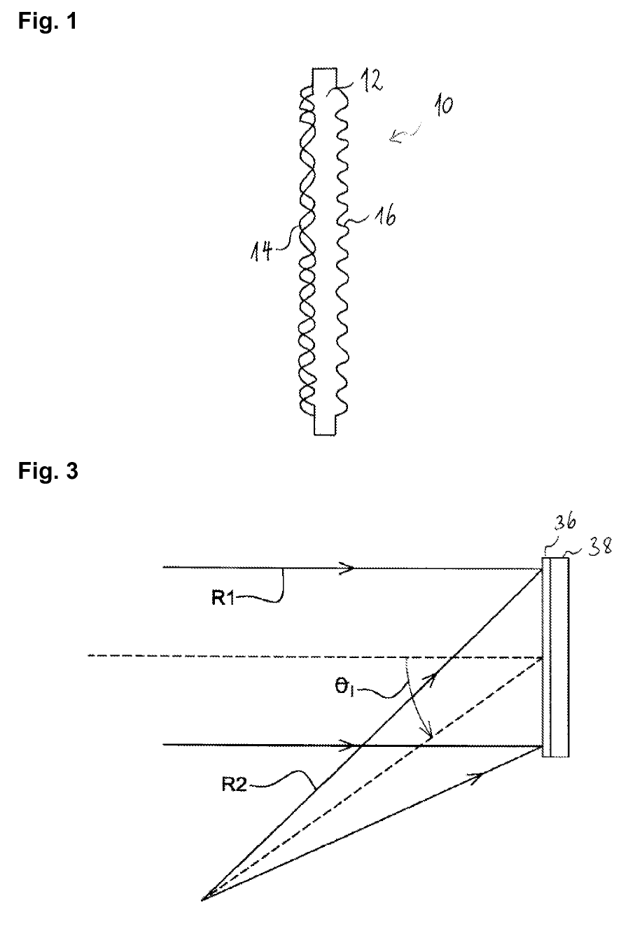

FIG. 1 shows diagrammatically a section of a diffractive combiner 10 for a “full-color” head-up display device. The combiner 10 comprises a support body 12 made of plastics material, e.g. PMMA, PC, PET, or PVB. The combiner 10 comprises a first 14 and a second 16 optical diffraction gratings formed in relief on the first and the second face respectively of the support body 12. Let us note that in FIG. 1 the dimensions of the combiner 10 are not to scale; in particular the thickness of the support body 12 and the amplitude (or the depth) of the reliefs are exaggerated. The thickness of the combiner is preferably within the range from 0.25 to 3 mm. The depth of the relief gratings is preferably within the range from 100 to 600 nm.

The first optical diffraction grating 14 is a multiplexed grating, while the second 16 is a single (non-multiplexed) grating.

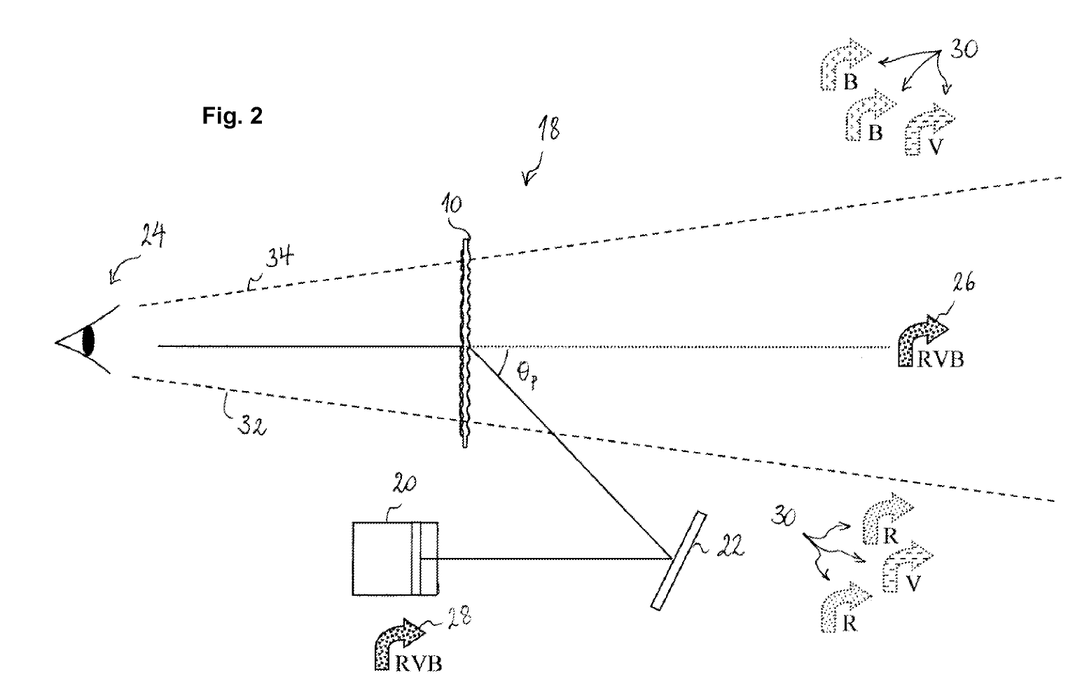

To explain the configuration of the optical diffraction gratings 14, 16 and the operation of the diffractive combiner 10, reference is made to FIG. 2. This shows diagrammatically a head-up display device 18 comprising a projection unit 20, the combiner 10 and optionally one or more optical elements (illustrated by the mirror 22) to guide the light beam emitted by the projection unit 20 onto the combiner 10.

The projection unit 20 comprises for example a “full-color” liquid crystal screen with backlighting by coherent light sources, preferably laser diodes. The image source is formed on a display (an optical diffusion layer) by additive synthesis of the red, green and blue monochromatic images produced by the pixels.

The light beam produced by the projection unit 20 is directed onto the combiner either directly or by means of an optical system. The light beam meets the combiner at an angle of incidence θp (the central ray of the beam being taken as reference). The optical diffusion layer of the projection unit 20 is preferably so selected that the angle of aperture of the projection unit 20 (the angle of divergence of the light beam) more or less corresponds to the angle subtended by the diffractive combiner 10.

The light beam emitted by the projection unit therefore contains light of a first wavelength corresponding to red (e.g. 633 nm), light of a second wavelength corresponding to green (e.g. 532 nm) and of a third wavelength corresponding to blue (e.g. 432 or 445 nm). The angle of incidence θp is therefore the same for the three wavelengths involved.

A conventional diffractive combiner, provided with only one single optical diffraction grating, would bend the light of the beam by an angle dependent on the wavelength. Consequently, an observer would see red, green, and blue virtual images offset relative to each other. For this reason, the combiner 10 comprises a first optical diffraction grating for red, as well as a multiplexed optical diffraction grating for green and blue, so configured that the first order of diffraction of the red, of the green and of the blue respectively occur in the same direction. A user 24 (e.g. the driver of a motor vehicle equipped with the head-up display device) therefore sees a virtual image in color 26 of the source image 28. The distance of the virtual image in color 26 from the diffractive combiner 10 depends on the path of the source image 28 as well as on the focal length of a possible lens formed by the diffractive combiner. The head-up display device 18 is preferably so configured that the virtual image is situated at a distance of between 1 and 5 m from the diffractive combiner 10.

In fact, the diffractive combiner 10 assumes the function of three single gratings, each of which is configured to bend a particular color in the required direction. In the combiner 10, two of these single gratings are formed in multiplexed manner on the first face of the support body, while the third is situated on the opposite face (the second face). Obviously, each of these gratings interacts with all the wavelengths present in the light beam emitted by the projection unit 20. Parasitic virtual images 30 are therefore observed (red, green and blue respectively), on either side of the virtual image 26 in color. The angle of incidence θp, the angle of deviation, the pitch of the optical diffraction gratings, the size of the combiner, etc. are therefore so selected to move the parasitic virtual images 30 out of the field of view of the user 24. In FIG. 2, the limit of the field of view of the user is illustrated by the broken lines 32 and 34.

Let us note that in the diffractive combiner of FIGS. 1 and 2 the multiplexed optical diffraction grating 14 is the one that bends the green light and the blue light in the direction of the user 24. The other optical diffraction grating 16 is the single (non-multiplexed) grating that bends the red light in the said direction. This construction of the diffractive combiner 10 provides better diffraction efficiency (in the direction of the user) for red light than for green and blue light. In practical terms, a luminance in red can easily be obtained in the virtual image which is double that in green or blue. Given that the sensitivity of the human eye to green is greater than its sensitivity to red and to blue both under conditions of low light (scotopic vision) and under daylight conditions (photopic vision) and that blue is the color the least present in nature, a balanced composition is therefore obtained with light sources in blue, green and red, of the same optical intensity. Obviously, if the light sources of the projection unit used are of unequal power, a different configuration of the diffractive combiner can be selected.

FIG. 3 shows the process for manufacture of the diffractive combiner 10 by laser interference nanolithography. For each of the gratings, a matrix is firstly recorded. In FIG. 3, the rays R1 and R2 respectively represent the object rays and the reference rays. The two rays produce fringes in a layer of the photosensitive resin 36 applied to a substrate 38 (of quartz, silicon, glass, or other). The interferences of R1 and R2 in the photosensitive layer 36 permit exposure to light of precise zones, which modifies the solubility of the resin in these zones. The exposed zones of the photosensitive resin thus become more or less soluble relative to the other zones. Chemical engraving then allows the removal of the zones not exposed to light (or exposed to light depending on the type of photosensitive resin: negative or positive) so as to obtain a diffractive surface structure.

The angle θi between R1 and R2 is adjusted according to the formula θi=arcsin((λe/λi)*sin(θp)), in which θp corresponds to the angle of incidence of the light beam from the projection unit, λe is the wavelength of the beams used for the recording, λi the wavelength of the light to be diffracted.

For an angle of incidence θp of 32°, assuming the light must be bent along an axis perpendicular to the diffractive combiner and assuming a writing wavelength λe=406 nm, we obtain for example:

| Color | λi | θi |
|---|---|---|
| Blue | 445 nm | 28.9° |
| Green | 532 nm | 23.8° |
| Red | 633 nm | 19.8° |

To record the non-multiplexed optical diffraction grating 16, the matrix is therefore generated by causing the beams R1 and R2 (λe=406 nm) to interfere at an angle of 19.8°, R1 being perpendicular to the photosensitive layer. Then, the chemical engraving is performed and the relief obtained is transposed into a first part of the mold.

To record the multiplexed optical diffraction grating 14, another matrix is generated, by causing the beams R1 and R2 (λe=406 nm) to interfere at an angle of 23.8°, R1 being perpendicular to the photosensitive layer. Then, we move on to the angle of 28.9° (R1 remaining perpendicular to the photosensitive layer). After the chemical engraving, the relief obtained is transposed into a second part of the mold.

The diffractive combiner is finally formed of transparent plastics material by injection molding or by embossing by means of the first and second parts of the mold.

In the setup of FIG. 3, the beam R1 is normal to the surface of the photosensitive layer. As a result, the diffracted light leaves perpendicularly to the diffractive combiner. If it is preferred to obtain an observer-color virtual image axis inclined at an angle θ′ relative to the normal to the combiner, it is only necessary to produce a recording setup in which the beam R1 is inclined by the angle θ′ relative to the normal to the photosensitive layer 36. In this case, θi corresponds to the angle between R2 and the normal to the photosensitive layer 36. The angle between R1 and R2 will be θi−θ′.

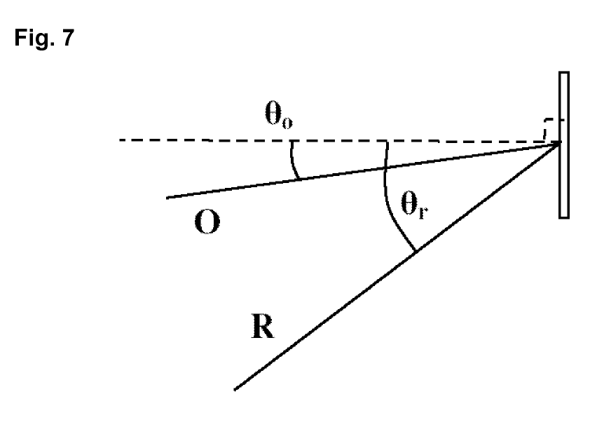

FIG. 7 shows the more general case of a recording configuration in which the two writing beams R1 and R2 form an angle θo, θr respectively relative to the normal to the photosensitive layer. In this configuration, the pitch d of the (single) grating formed is given by the equation:

d=λe/(sin(θr)−sin(θo) (Eq. 2)

On recording of a multiplexed grating, the superimposition of the single gratings results in a variable (modulated) grating pitch because a plurality of values of θr is used. In the following discussion, we are however going to consider single gratings.

When the combiner is used, the angle of incidence θp of the beam from the projection unit is given by the equation 1 (substituting θr for θi). The angle of diffraction θ_{d} is given by:

θd=arcsin(λi/d−sin(θp)) (Eq. 3)

in which λᵢ designates the new wavelength of the light from the projection unit.

The following table gives two examples of geometric configurations permitting illustration of the spacing between diffracted rays of different colors.

| | | | | angular | angular |
|---|---|---|---|---|---|
| | | | | spacing | spacing |
| | | | | B-V | V-R |
| | θp | λi (nm) | θd (degrees) | (degrees) | (degrees) |
| Case 1 | 21 | 432 (blue) | 0 | 5 | 4.8 |
| | | 532 (green) | 5 | | |
| | | 633 (red) | 9.8 | | |
| Case2 | 54.2 | 432 (blue) | −4.8 | 9.8 | 9.9 |
| | | 532 (green) | 5 | | |
| | | 633 (red) | 14 | | |

In the case 1 for an angle θp=20° the angular spacing between the blue and green images is 5°, and the angle between the green and red images is 4.8 degrees.

For an angle θp=54.2° the angular spacing between the blue and green images becomes 9.8° and that between the green and red images becomes 9.9°. It will be noted that when the pitch of the grating d is reduced, the angular spacing between the images of different colors increases.

The control of the angular spacing between the parasitic virtual images is therefore effected by the selection of θp which involves the selection of the angle between the reference beam and the object beam. This angle will determine the pitch of the grating and consequently the angle of diffraction.

In the case in which the diffractive combiner has to perform a lens function, the distance between the photosensitive layer 36 and the center of the spherical wavefronts of the beam R2 must be adapted in accordance with the formula: f1=(λe/λi)*fe, in which fi designates the focal length of the required lens, fe designates the focal length corresponding to the spherical wave R2, λe designates the wavelength of the laser used for recording the lens, and λi(i−1,2,3) designates the wavelength of the light from the projector.

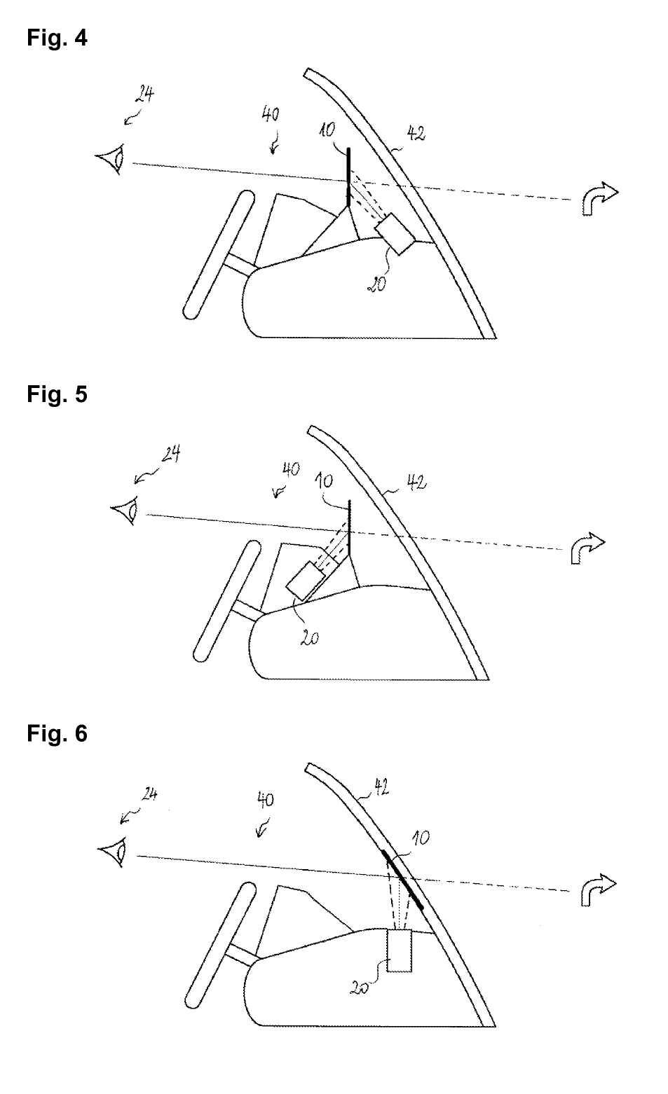

FIG. 4 shows, in simplified manner, the dashboard 40 of a motor vehicle equipped with a head-up display device such as shown for example in FIG. 2. The diffractive combiner 10 is constructed to operate in transmission. From the point of view of the user 24, the diffractive combiner 10, positioned in front of the windscreen 42, is backlit by the projection unit 20.

FIG. 5 shows an alternative embodiment of a head-up display device, in which the diffractive combiner is constructed in reflection. The projection unit 20 is situated behind the instrument panel cluster and lights the diffractive combiner from in front (seen by the user). One or more optical reflection layers are formed on the rear face (from the point of view of the user) of the diffractive combiner to reflect the light coming from the projection unit towards the user. These reflection layers can be partially reflecting or dichroic layers, adapted to the wavelengths used in the projector.

Another alternative is shown in FIG. 6. Here, the diffractive combiner 10 forms part of the windscreen 42. More particularly, the multiplexed and non-multiplexed optical diffraction gratings are formed in relief in the surfaces of a layer of plastics material of the windscreen 42.

### KEY

10 Diffractive combiner
12 Support body
14 First optical diffraction grating
16 Second optical diffraction grating
18 Head-up display device
20 Projection unit
22 Mirror
24 User
26 Virtual colour image
28 Source image
30 Parasitic virtual images
32, 34 Limit of the field of view of the user
36 Photosensitive resin layer
38 Substrate
40 Dashboard
42 Windscreen

1. A diffractive combiner for a head-up display device, said combiner comprising a first optical diffraction grating configured to diffract, in a direction of diffraction, light of a first incident wavelength onto said first optical diffraction grating in a direction of incidence, a second optical diffraction grating configured to diffract, in said direction of diffraction, light of a second incident wavelength onto said second optical diffraction grating in said direction of incidence, said combiner comprising:
a support made of transparent material having opposed first and second faces on that are formed in relief respectively the first and second optical diffraction gratings, wherein at least one of the first and second optical diffraction gratings is a wavelength multiplexed optical diffraction grating configured to diffract, in the said direction of diffraction, light of a third incident wavelength onto at least one of the first and second optical diffraction gratings in the said direction of incidence.

2. The diffractive combiner as described in claim 1, wherein the light of the first wavelength is green light, the light of the second wavelength is red light, and the light of the third wavelength is blue light.

3. The diffractive combiner as described in claim 1, wherein the support is made of glass or of transparent polymeric material.

4. The diffractive combiner as described in claim 1, wherein the first and second optical diffraction gratings are configured such that the direction of diffraction corresponds to the first order of diffraction of each of the first, second, and third wavelengths.

5. The diffractive combiner as described in claim 1, wherein the first and second optical diffraction gratings are configured to perform a lens function characterized as having the same focal length for the light of the first, second, and third wavelengths.

6. A head-up display device comprising:
a projection unit able to project a light beam having light of a first wavelength, light of a second wavelength, and light of a third wavelength from a color image produced by superimposition of monochromatic images of different colors, each of which corresponds to one of the said wavelengths respectively; and
a diffractive combiner as described in claim 1, said diffractive combiner positioned relative to the projection unit effective to receive the light beam projected by the projection unit in the direction of incidence, and to diffract at least a part of the light of the first, second, and third wavelengths of the light beam in the direction of diffraction effective to create in a field of view of a user a virtual color image of the image produced by the projection unit.

7. The head-up display device as described in claim 6, wherein the first and second optical diffraction gratings of the diffractive combiner are configured to position the virtual image at a distance within the range of one meter to three meters from the diffractive combiner.

8. The head-up display device as described in claim 6, in combination with the diffractive combiner as described in claim 4, wherein the first and second optical diffraction gratings of the diffractive combiner are adjusted to the positioning of the diffractive combiner so as to place parasitic virtual images outside the field of view of the user.

9. The head-up display device as described in claim 8, wherein the direction of incidence and the direction of diffraction form between them an angle effective to place the parasitic virtual images outside the field of view of the user.

10. The head-up display device as described in claim 6, wherein the diffractive combiner is constructed to operate in transmission.

11. The head-up display device as described in claim 6, wherein the diffractive combiner is constructed to operate in reflection.

12. The head-up display device as described in claim 11, wherein the diffractive combiner comprises one or more optical reflection layers adapted to the wavelengths used in the projection unit.

13. The head-up display device as described in claim 6, wherein the diffraction efficiencies of the diffractive combiner for the first, second, and third wavelengths are selected as a function of the luminance level of the virtual color image or as a function of the color balance corresponding to the first, second, and third wavelengths in the virtual image.

14. The head-up display device as described in claim 13, wherein the diffraction efficiencies of the diffractive combiner are adjusted by controlling the depth of the reliefs of the first and second optical diffraction gratings of the diffractive combiner.
